(19) United States
(12) Patent Application Publication
(10) Pub. No.: US 2001/0051276 A1
(43) Pub. Date: Dec. 13, 2001

(54) Method for improving bonding of rigid, thermosetting compositions to hydrophilic surfaces, and the articles formed thereby

(76) Inventor: Ki-Soo Kim, Katonah, NY (US)

Correspondence Address: CANTOR COLBURN, LLP, 55 GRIFFIN ROAD SOUTH, BLOOMFIELD, CT, 06002

(21) Appl. No.: 09/833,212

(22) Filed: Apr. 11, 2001

Related U.S. Application Data
(60) Provisional application No. 60/196,317, filed on Apr. 12, 2000.

(51) Int. Cl. B05D 3/02; B05D 1/36; B32B 17/10

(52) U.S. Cl. 428/442; 428/463; 428/517; 427/385.5; 427/407.1

(57) ABSTRACT

A process for adhering hydrophilic metal surfaces and rigid, thermosetting substrate compositions comprises contacting a hydrophilic metal surface with an adhesion promoter comprising an aqueous solution of zinc diacrylate, zinc dimethacrylate or a combination thereof and a carrier, drying the adhesion promoter solution to form an adhesion promoting layer, contacting the adhesion promoting layer with a curable thermosetting composition, and curing the thermosetting composition. The adhesion promoting solution contains from about 1.5 weight percent (wt. %) to about 20 wt. % of zinc diacrylate, zinc dimethacrylate or a combination thereof and from about 1 wt. % to about 20 wt. % of a carrier, preferably polyvinyl alcohol. Preferably the polyvinyl alcohol has a molecular weight of from about 7,000 to about 15,000 for maximum enhancement of the bonding. Quite unexpectedly, use of the aqueous adhesion promoting solution increased the peel strength (pli) by about 0.5 pli to about 5 pli, an improvement of up to 110%. Additionally no undercut was seen after exposure to a sulfuric acid solution in laminate materials prepared with the aqueous adhesion promoting solution.

### BACKGROUND OF THE INVENTION

1. Field of the Invention

This invention relates to methods for improving the bond strength between the hydrophilic surface and a rigid, thermosetting substrate, and in particular to a hydrophilic metal surface and a circuit board substrate, as well as the articles formed thereby.

2. Description of the Related Art

Circuit board materials are well-known in the art, generally comprising a thermosetting substrate adhered to a conductive metal surface. In order to make electronic devices smaller, there is strong motivation to make circuit layouts as dense as possible. To that end, it is necessary to have circuit board materials with a low dielectric constant and a high glass transition temperature. However, when rigid thermosetting compositions with low dielectric constant and high glass transition temperature are used, the resulting circuit board material has a low peel strength between the metal layer and the substrate. Peel strength may be even more severely reduced when low or very low profile copper foils are employed, such foils being critical to very dense circuit designs.

A number of efforts have been made to improve the bonding between the substrate material and the surface of the metal, which is generally hydrophilic. U.S. Pat. No. 5,904,797 to Kwei discloses using chromium (III) methacrylate/polyvinyl alcohol solutions to improve bonding between thermoset resins and hydrophilic surfaces. The chromium methacrylate chemically bonds the thermoset resin to the hydrophilic surface. While chromium methacrylate is useful for some thermoset resins, it is not useful for all, notably polybutadiene and polyisoprene resins. PCT Application No. 96/19067 to McGrath discloses contacting the metal surface with an adhesion promoting composition comprising hydrogen peroxide, an inorganic acid, a corrosion inhibitor, and a quaternary ammonium surfactant.

PCT Application No. 99/57949 to Holman discloses using an intermediate layer comprising a high molecular weight organic resin, preferably an epoxy or phenoxy resin, to improve the peel strength of a laminate. This method increases the thickness of the final laminate by the introduction of an additional layer, which can be a liability when the ultimate goal is dense circuit designs.

### SUMMARY OF THE INVENTION

A process for adhering hydrophilic metal surfaces and rigid, thermosetting substrate compositions comprises contacting a hydrophilic metal surface with an adhesion promoter comprising an aqueous solution of zinc diacrylate, zinc dimethacrylate or a combination thereof and a carrier, drying the adhesion promoter solution to form an adhesion promoting layer, contacting the adhesion promoting layer with a curable thermosetting composition, and curing the thermosetting composition. The adhesion promoting solution contains from about 1.5 weight percent (wt. %) to about 20 wt. % of zinc diacrylate, zinc dimethacrylate or a combination thereof and from about 1 wt. % to about 20 wt. % of a carrier, preferably polyvinyl alcohol. Preferably the polyvinyl alcohol has a molecular weight of from about 7,000 to about 15,000 for maximum enhancement of the bonding.

In another embodiment, a metal-thermoset article is formed by adhering hydrophilic metal surfaces and rigid, thermosetting substrate compositions by a process comprising contacting a hydrophilic metal surface with an adhesion promoter comprising an aqueous solution of a zinc diacrylate, zinc dimethacrylate or a combination thereof and a carrier, drying the adhesion promoter solution, contacting the dried adhesion promoter with a curable thermosetting composition, and curing the thermosetting compositions. Such articles find particular utility as circuit boards.

The above-described method may be used in a variety of applications, but is particularly suited to the production of a circuit material with increased peel strength. The circuit material comprises a thermosetting composition adhered to a hydrophilic surface of a metal layer by an adhesion promoting layer comprising a carrier, an optional latex and a zinc diacrylate, zinc dimethacrylate or a combination of a zinc diacrylate and zinc dimethacrylate, wherein both the thermosetting composition and the hydrophilic surface are in contact with the adhesion promoting layer.

The above-discussed and other features and advantages of the present invention will be appreciated and understood by those skilled in the art from the following detailed description.

### BRIEF DESCRIPTION OF THE DRAWINGS

Referring now to the exemplary drawing,

FIG. 1 is a schematic representation of a circuit material.

### DETAILED DESCRIPTION OF THE PREFERRED EMBODIMENTS

A method for enhancing the adhesion between a hydrophilic metal surface and the surface of a curable thermosetting composition comprises contacting the hydrophilic metal surface with an aqueous adhesion promoting solution comprising zinc diacrylate, zinc dimethacrylate or a combination thereof and a carrier; allowing the solution to dry; applying the curable thermosetting composition; and curing the thermosetting composition. Quite unexpectedly, use of an aqueous solution of a metal diacrylate, metal dimethacrylate or a combination thereof causes a large and synergistic increase in both the tensile bond strength between the hydrophilic surface and thermoset resin and the uniformity of the tensile bond strength. This result is particularly surprising because such results are not obtained using similar Cr(III) methacrylate solutions.

A suitable zinc diacrylate is commercially available from Sartomer Company, Inc. under the trade name SR 705 Metallic Diacrylate. The adhesion promoting solution contains from about 0.5 weight percent (wt. %) to about 20 wt. %, and preferably from about 1.0 wt. % to about 15 wt. % of zinc diacrylate, zinc dimethacrylate or a combination thereof.

The carrier is present so as to maintain the zinc diacrylate, zinc dimethacrylate or a combination thereof in the form of a thin film after evaporation of the water. Without use of a carrier, the zinc diacrylate, zinc dimethacrylate or a combination thereof dries on the zinc surface in the form of a powder, which does not provide optimal bonding. Useful carriers include PVA and PVA copolymers. A preferred carrier is low molecular weight PVA. Suitable low molecular weight PVA is preferably fully hydrolyzed (98-99%) and has a molecular weight of 5,000 to 200,000, and preferably a molecular weight of from about 7,000 to about 15,000. Low molecular weight poly(vinyl alcohol) (PVA) is commercially available. For example, AIRVOL® 103 and AIRVOL® 203 poly(vinyl alcohol) are available from Air Products and Chemicals, Allentown Pa. and ELVANOL® poly(vinyl alcohol) from the E.I. DuPont de Nemours and Company, Wilmington, Del. The carrier is generally present in the aqueous solution in amounts from about 1 wt. % to about 20 wt. %, and preferably from about 2.5 wt. % to about 15 wt. % by weight.

In addition, PVA crosslinkers such as a melamine-formaldehyde resin (commercially available as CYMEL 350 from Cytec Industries Inc.) and cationic amine epichlorohydrin adducts (commercially available from Hercules Inc. under the trade name POLYCUP 172), can be added to reduce swelling in water and to improve hydrolytic stability of the dried adhesion promoter. In addition, latex containing nonionic surfactants (such as ROVENE 4040 SBR latex available from Millard Creek Polymers, Inc.) can be added to reduce swelling in copper etchant and photoresist stripping solution. Wetting agents may also be added to improve substrate wetting during coating. Wetting agents are well known in the art and are commercially available. Defoamers can be added to reduce foaming during spray coating. Defoamers are well known in the art and are commercially available.

Hydrophilic surfaces suitable for use herein include surfaces provided by one or more of the following materials: metals (such as copper, aluminum, zinc, iron, transition metals, and their alloys), glass silica, fibers and polymeric surfaces or polymeric surfaces pretreated to become hydrophilic, such as by plasma or corona discharge. There are no limitations regarding the thickness of the hydrophilic material, nor are there any limitations as to the shape, size or texture of the surface. Additionally, the hydrophilic surface may be used as obtained from the supplier (oxidized in the case of metals) or subsequent to a cleaning procedure such as burnishing.

Suitable thermosetting compositions employ resins that cure by a free radical process. Such resins include rubber, polyester, vinyl, acrylic, polybutadiene, polyisoprene, polybutadiene and polyisoprene copolymers, polyurethane resins and combinations comprising one of the foregoing resins. Compositions containing polybutadiene, polyisoprene, and/or polybutadiene and polyisoprene copolymers are especially preferred. The thermosetting compositions may also include particulate fillers, elastomers, flame retardants, and other components known in the art.

In general, the thermosetting compositions are processed as described in U.S. Pat. No. 5,571,609 to St. Lawrence et al. which is incorporated by reference herein. A preferred thermosetting composition generally comprises: (1) a polybutadiene or polyisoprene resin or mixture thereof; (2) an optional unsaturated butadiene- or isoprene-containing polymer capable of participating in crosslinking with the polybutadiene or polyisoprene resin during cure; and (3) an optional ethylene propylene rubber (ethylene propylene copolymer (EPM) or ethylene propylene diene terpolymer (EPDM)).

The aqueous adhesion promoting solution is prepared by adding the desired amounts of zinc diacrylate, zinc dimethacrylate or a combination thereof and other optional ingredients to a solution containing the desired concentration of PVA in water and mixing thoroughly. This solution is applied to the hydrophilic surface, for instance a copper surface, by dip-, spray-, wash- or other coating technique to provide a weight pick up of the solution on the copper foil after drying of from about 0.05 to about 1.5 mg/cm² and preferably from about 0.3 to about 1.0 mg/cm².

The solution is allowed to dry under ambient conditions or by forced or heated air, and the thermosetting composition is applied to the dried and treated hydrophilic surface. The thermosetting composition is cured and the laminated material is formed by an effective quantity of temperature and pressure, which will depend upon the particular thermosetting composition. Alternatively, the thermosetting composition can be cured by other methods well known to those skilled in the art such as microwave, electron beam, and catalytic methods and then laminated with the hydrophilic surface using heat and pressure.

Use of the aqueous adhesion promoting solutions as described above resulted in an increased peel strength of the bilayer of about 0.5 pounds per linear inch (pli) to about 5 pli, an improvement of up to 110%. Additionally no undercut was observed in laminate materials prepared with the aqueous adhesion promoting solution after exposure to a sulfuric acid solution (undercut is penetration or attack along the metal-polymer bond line which leads to bond reduction). Laminate material prepared without the aqueous adhesion promoting solution showed a 4.5 mil undercut.

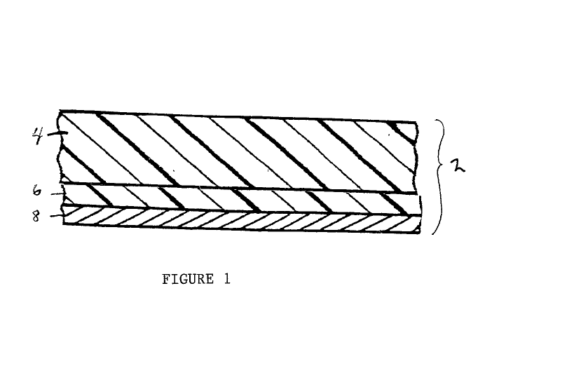

Accordingly, the above-described method may be used to produces a circuit material with increased peel strength. The circuit material comprises a thermosetting composition adhered to a hydrophilic surface of a metal layer by an adhesion promoting layer comprising a carrier, an optional latex and a zinc diacrylate, zinc dimethacrylate or a combination of a zinc diacrylate and zinc dimethacrylate, wherein both the thermosetting composition and the hydrophilic surface are in contact with the adhesion promoting layer. FIG. 1 is a schematic representation of an exemplary circuit material. Circuit material 2 comprises a thermosetting composition 4 disposed adjacent to adhesion promoting layer 6 which, in turn, is disposed adjacent to a hydrophilic surface 8. Preferably the metal layer is copper. The thermosetting composition preferably comprises polybutadiene, polyisoprene, polybutadiene copolymer, polyisoprene copolymer or combination comprising one of the foregoing resins. The circuit material has excellent bond strength as discussed above.

The invention is further illustrated by the following non-limiting Examples.

### EXAMPLES

### Examples 1-8

Examples 1-4 are controls and Examples 5 and 6 are comparative examples using a chromium (III) methacrylate (VOLAN from the E. I. DuPont de Nemours and Company, Wilmington, Del.) and PVA (AIRVOL 103 from Air Products) solution. Examples 7-10 use an aqueous solution of zinc diacrylate (ZDA) (SR 705 from Sartomer) and PVA (AIRVOL 103 from Air Products). The solutions were all applied to 1 oz. TWX copper foil (Yates Foil, USA), the copper foil was dried, and then an R04350B prepreg (a polybutadiene-based thermosetting composition) was applied. Lamination temperatures, weight percentages of VOLAN, PVA and ZDA, and peel strength are shown in Table 1. Peel strength was tested in accordance with IPC-TM-650.

TABLE 1

| No. | Foil treatment | Lamination, ° F. | Peel Strength, pli |
|---|---|---|---|
| 1* | None | 375 | 4.5 |
| 2* | None | 395 | 4.7 |
| 3* | 5% ZDA | 375 | 3.9 |
| 4* | 5% PVA | 395 | 4.6 |
| 5** | 5%/5% VOLAN/PVA | 375 | 4.8 |
| 6** | 5%/10% VOLAN/PVA | 375 | 1.7 |
| 7 | 5%/5% ZDA/PVA | 375 | 5.2 |
| 8 | 5%/5% ZDA/PVA | 395 | 5.4 |
| 9 | 10%/5% ZDA/PVA | 375 | 5.7 |
| 10 | 10%/5% ZDA/PVA | 395 | 5.9 |

*Control
**Comparative Example in accordance with U.S. Pat. No. 5,904,797

Table 1 shows that peel strength is significantly increased to 5.7-5.9 pli from 4.5-4.7 pli by treating the copper foil with 10%/5% ZDA/PVA solution. Comparative samples 5 and 6 according to U.S. Pat. No. 5,904,797 using VOLAN/PVA do not show any increases in bond as compared to controls 1 and 2.

### Examples 11-20

Example 11 is a comparative example which does not employ a ZDA/PVA solution. Examples 12-20 use aqueous solution with varying wt. % of zinc diacrylate and PVA applied to 1 oz. TWX copper foil. The copper foil was dried then laminated at 395° F. with R04350B. Weight percentages of PVA and ZDA, weight pick up and peel strength are shown in Table 2. Weight pickup is measured by weighing the sample before and immediately after coating, after the coating dries. The difference, which is the weight of the total ZDA/PVA applied, is divided by the total surface area of the sample, and is expressed in mg/cm².

TABLE 2

| No. | ZDA/PVA, %/% | Weight pick-up, mg/cm² | Peel Strength, pli |
|---|---|---|---|
| 11* | None | 0 | 4.3 |
| 12 | 10/5 | 0.16 | 4.9 |
| 13 | 15/5 | 0.23 | 5.8 |
| 14 | 10/7.5 | 0.24 | 6.6 |
| 15 | 10/10 | 0.29 | 7.8 |
| 16 | 15/7.5 | 0.28 | 6.1 |
| 17 | 10/10 | 0.30 | 8.3 |
| 18 | 10/10 | 0.31 | 8.1 |
| 19 | 10/10 | 0.31 | 8.3 |
| 20** | 10/10 | 0.55 | 10.6 |

*Control
**Coated twice

Table 2 shows that copper bond can be further increased by increasing the concentration of ZDA/PVA, in turn, increasing the weight pick-up of ZDA/PVA on the copper surface. Bond strengths of 8.1-8.3 pli are obtained with 10%/10% ZDA/PVA (one coat) and 10.6 pli with 10%/10% ZDA/PVA (two coats).

Other bond related properties of Example 17 were compared to those of the control Example 11. No undercut was seen in the laminate material of Example 17 when exposed to a 10% sulfuric acid solution at 75° C. for 5 minutes compared to a 4.5 mil undercut for the control example. The solder float effect on the bond for 10 seconds was tested and there was no change in the bond of Example 15 or control Example 11. Most importantly, electrical properties dielectric constant and dissipation factor of Example 15 at 10 GHz were comparable to those of the control example.

### Examples 21-23

Examples 21-23 employ an aqueous solution of ZDA and PVA containing a styrene-butadiene rubber latex (ROVENE 4040 SBR latex available from Millard Creek Polymers, Inc.), a crosslinker (CYMEL 350 available from Cytec Industries, Inc.), a wetting agent, polyether modified poly-dimethyl-siloxane (BYK 333 available from BYK Chemie), and p-toluenesulfonic acid (TSA). The aqueous solution was applied to ½ ounce TWX copper foil (Yates Foil, USA). Weight percentages of the aqueous solution components, weight pick up and peel strength are shown in Table 3. Example 24 is a control.

TABLE 3

| | ZDA/PVA/CYMEL/ | Weight pick-up, | Bond Strength, |
|---|---|---|---|
| Example | TSA/ROVENE/BYK | mg/cm² | pli |
| 21 | 10/5/0.5/0.01/1/0.01 | 0.58 | 4.4 |
| 22 | 5/10/0.5/0.01/2/0.01 | 0.58 | 4.7 |
| 23 | 5/10/0.5/0.01/1/0.01 | 0.66 | 5.1 |
| 24* | None | 0 | 4.1 |

Examples 21-23 demonstrate that application of a ZDA/PVA aqueous solution containing latex, crosslinker and wetting agent improves the copper bond.

Although the copper-clad laminates described in the examples were prepared by applying the aqueous adhesion promoting solution to the copper foil prior to lamination, it is anticipated that the aqueous adhesion promoting solution could be applied to the thermosetting composition prior to lamination of the copper foil. It is also specifically envisioned that copper foils can be pre-treated with the aqueous adhesion promoting solution and stored until needed for lamination.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A process for improving adhesion between a hydrophilic surface and a surface of a rigid, thermosetting composition comprising:
applying an adhesion promoting aqueous solution comprising zinc diacrylate, zinc dimethacrylate, or combination thereof and a carrier to the hydrophilic surface to form a coating;
drying the coating to form an adhesion promoting layer;
applying a thermosetting composition; and
curing the thermosetting composition.

2. The process of claim 1, wherein the adhesion promoting aqueous solution consists essentially of zinc diacrylate, zinc dimethacrylate, or a combination thereof.

3. The process of claim 1, wherein the adhesion promoting aqueous solution comprises about 0.5 wt. % to about 20 wt. % of zinc diacrylate, zinc dimethacrylate or combination thereof.

4. The process of claim 1, wherein the adhesion promoting aqueous solution comprises about 1.0 wt. % to about 15 wt. % of zinc diacrylate, zinc dimethacrylate or combination thereof.

5. The process of claim 1, wherein the carrier is a poly(vinyl alcohol) with a molecular weight of about 5,000 to about 200,000.

6. The process of claim 5, wherein the poly(vinyl alcohol) has a molecular weight of 7,000 to 15,000.

7. The process of claim 1, wherein the adhesion promoting aqueous solution comprises about 1.0 wt. % to about 40 wt. % of carrier.

8. The process of claim 1, wherein the adhesion promoting aqueous solution comprises about 2.5 wt. % to about 30 wt. % of carrier.

9. The process of claim 1, wherein the adhesion promoting aqueous solution further comprises a poly(vinyl alcohol) crosslinker.

10. The process of claim 1, wherein the adhesion promoting aqueous solution further comprises a latex containing nonionic surfactant.

11. The process of claim 1, wherein the adhesion promoting aqueous solution further comprises a wetting agent.

12. The process of claim 1, wherein the adhesion promoting aqueous solution further comprises a defoamer.

13. The process of claim 1, wherein the hydrophilic surface is selected from the group consisting of metals, glass, silica, fibers, hydrophilic polymeric surfaces and polymeric surfaces pretreated to become hydrophilic by plasma or corona discharge.

14. The process of claim 13, wherein the hydrophilic surface is selected from the group consisting of copper, aluminum, zinc, iron, transition metals, and their alloys.

15. The process of claim 1 wherein the thermosetting composition cures by free radical process.

16. The process of claim 15 wherein the thermosetting composition comprises polybutadiene, polyisoprene, polybutadiene copolymer, polyisoprene copolymer or a combination comprising one of the foregoing resins.

17. The process of claim 15 wherein the thermosetting composition further comprises a filler.

18. A process for improving adhesion between a copper surface and the surface of a rigid, thermosetting composition comprising:
applying an adhesion promoting aqueous solution comprising zinc diacrylate, zinc dimethacrylate, or combination thereof and a carrier to the copper surface to form a coating;
drying the coating;
applying a thermosetting composition; and
curing the thermosetting composition.

19. A process for improving adhesion between a copper surface and the surface of a rigid, thermosetting composition comprising:
applying an adhesion promoting aqueous solution comprising zinc diacrylate, zinc dimethacrylate, or combination thereof and a carrier to the copper surface;
drying the coating;
applying a thermosetting composition comprising polybutadiene, polyisoprene, polybutadiene copolymer, polyisoprene copolymer or combination comprising one of the foregoing resins; and
curing the thermosetting composition.

20. An article of manufacture formed by the method of claim 1.

21. A circuit material produced by the process comprising applying an adhesion promoting aqueous solution comprising zinc diacrylate, zinc dimethacrylate, or combination thereof and a carrier to a hydrophilic surface to form a coating;
drying the coating;
applying a thermosetting composition; and
curing the thermosetting composition.

22. The circuit material of claim 21, wherein the adhesion promoting solution consists essentially of zinc diacrylate, zinc dimethacrylate, or a combination thereof.

23. The circuit material of claim 21, wherein the adhesion promoting aqueous solution comprises about 0.5 wt. % to about 20 wt. % of zinc diacrylate, zinc dimethacrylate or combination thereof.

24. The circuit material of claim 21, wherein the adhesion promoting aqueous solution comprises about 1.0 wt. % to about 15 wt. % of zinc diacrylate, zinc dimethacrylate or combination thereof.

25. The circuit material of claim 21, wherein the carrier is a poly(vinyl alcohol) with a molecular weight of about 5,000 to about 200,000.

26. The circuit material of claim 25, wherein the poly(vinyl alcohol) has a molecular weight of 7,000 to 15,000.

27. The circuit material of claim 21, wherein the adhesion promoting aqueous solution comprises about 1.0 wt. % to about 40 wt. % of carrier.

28. The circuit material of claim 21, wherein the adhesion promoting aqueous solution comprises about 2.5 wt. % to about 30 wt. % of carrier.

29. The circuit material of claim 21, wherein the adhesion promoting aqueous solution further comprises a poly(vinyl alcohol) crosslinker.

30. The circuit material of claim 21, wherein the adhesion promoting aqueous solution further comprises a latex containing nonionic surfactants.

31. The circuit material of claim 21, wherein the adhesion promoting aqueous solution further comprises a wetting agent.

32. The circuit material of claim 21, wherein the adhesion promoting aqueous solution further comprises a defoamer.

33. The circuit material of claim 21, wherein the hydrophilic surface is selected from the group consisting of metals, glass, silica, fibers, hydrophilic polymeric surfaces and polymeric surfaces pretreated to become hydrophilic by plasma or corona discharge.

34. The circuit material of claim 33, wherein the hydrophilic surface is selected from the group consisting of copper, aluminum, zinc, iron, transition metals, and their alloys.

35. The circuit material of claim 21 wherein the thermosetting composition cures by free radical process.

36. The circuit material of claim 35 wherein the thermosetting composition comprises polybutadiene, polyisoprene, polybutadiene copolymer, polyisoprene copolymer or a combination comprising one of the foregoing resins.

37. The circuit material of claim 35 wherein the thermosetting composition further comprises a filler.

38. A circuit material produced by the process comprising
applying an adhesion promoting aqueous solution comprising zinc diacrylate, zinc dimethacrylate, or combination thereof and a carrier to a copper surface to form a coating;
drying the coating;
applying a thermosetting composition; and
curing the thermosetting composition.

39. A circuit material produced by the process comprising applying an adhesion promoting aqueous solution comprising zinc diacrylate, zinc dimethacrylate, or combination thereof and a carrier to a copper surface to form a coating;
drying the coating;
applying a thermosetting composition comprising polybutadiene, polyisoprene, polybutadiene copolymer, polyisoprene copolymer or combination comprising one of the foregoing resins; and
curing the thermosetting composition.

40. A circuit material comprising
a thermosetting polymer layer;
a metal layer having a hydrophilic surface; and
an adhesion promoting layer disposed between at least a portion of the thermosetting polymer layer and at least a portion of the hydrophilic surface of the metal layer, wherein the adhesion promoting layer comprises a carrier and zinc diacrylate, zinc dimethacrylate or a combination of a zinc diacrylate and zinc dimethacrylate.

41. The circuit material of claim 40, wherein the adhesion promoting layer consists essentially of a carrier and zinc diacrylate, zinc dimethacrylate, or a combination thereof.

42. The circuit material of claim 40, wherein the carrier is a poly(vinyl alcohol) with a molecular weight of about 5,000 to about 200,000.

43. The circuit material of claim 42, wherein the poly(vinyl alcohol) has a molecular weight of 7,000 to 15,000.

44. The circuit material of claim 40, wherein the adhesion promoting layer further comprises a poly(vinyl alcohol) crosslinker.

45. The circuit material of claim 40, wherein the adhesion promoting layer further comprises a latex.

46. The circuit board material of claim 40, wherein the hydrophilic surface is selected from the group consisting of metals, glass, silica, fibers, hydrophilic polymeric surfaces and polymeric surfaces pretreated to become hydrophilic by plasma or corona discharge.

47. The circuit board material of claim 46, wherein the hydrophilic surface is selected from the group consisting of copper, aluminum, zinc, iron, transition metals, and their alloys.

48. The circuit board material of claim 47 wherein the thermosetting composition comprises polybutadiene, polyisoprene, polybutadiene copolymer, polyisoprene copolymer or a combination comprising one of the foregoing resins.

49. The circuit board material of claim 48 wherein the thermosetting composition further comprises a filler.

50. A circuit material comprising
a thermosetting polymer layer;
a metal layer having a hydrophilic surface; and
an adhesion promoting layer disposed between at least a portion of the thermosetting polymer layer and at least a portion of the hydrophilic surface of the metal layer, wherein the adhesion promoting layer comprises a carrier and zinc diacrylate, zinc dimethacrylate or a combination of a zinc diacrylate and zinc dimethacrylate and further wherein the thermosetting composition comprises polybutadiene, polyisoprene, polybutadiene copolymer, polyisoprene copolymer or a combination comprising one of the foregoing resins.
